(19) United States
(12) Patent Application Publication
(10) Pub. No.: US 2020/0359398 A1
(43) Pub. Date: Nov. 12, 2020

(54) USER EQUIPMENT AND BASE STATION APPARATUS

(71) Applicant: NTT DOCOMO, INC., Tokyo (JP)

(72) Inventors: Hideaki Takahashi, Chiyoda-ku, Tokyo (JP); Yousuke Sano, Chiyoda-ku, Tokyo (JP); Hiromasa Umeda, Chiyoda-ku, Tokyo (JP)

(73) Assignee: NTT DOCOMO, INC., Tokyo (JP)

(21) Appl. No.: 16/762,334

(22) PCT Filed: Nov. 14, 2018
(86) PCT No.: PCT/JP2018/042121

§ 371 Date: May 7, 2020

(30) Foreign Application Priority Data
Nov. 14, 2017 (JP) 2017-219472

(51) Int. Cl. H04W 72/12

(52) U.S. Cl. CPC H04W 72/1268

(57) ABSTRACT

User equipment communicates with a base station apparatus. The user equipment includes a generating unit that generates terminal capability information including information indicating an uplink band combination; information indicating whether simultaneous transmissions in the uplink band combination is allowed; and information indicating maximum sensitivity degradation when the simultaneous transmissions are executed in the uplink band combination; a transmitting unit that transmits the generated terminal capability information to the base station apparatus; and a receiving unit that receives an uplink scheduling allocation from the base station apparatus. The user equipment executes the simultaneous transmissions in the uplink band combination based on the uplink scheduling allocation.

### TECHNICAL FIELD

The present invention relates to user equipment and a base station apparatus of a radio communication system.

### BACKGROUND ART

Currently, in Third Generation Partnership Project (3GPP), drafting of specifications has been progressing towards a new radio communication system, which is called a New Radio Access Technology (NR) system, as a successor to the Long Term Evolution (LTE) system and the LTE-Advanced system (see Non-Patent 1, for example).

For the NR system, introduction of technology called LTE-NR dual connectivity or Multi-Radio Access Technology (Multi-RAT) dual connectivity has been studied such that, similar to the dual connectivity in the LTE system, data is divided between a base station (eNB) of the LTE system and a base station (gNB) of the NR system, and the data is simultaneously transmitted and received by these base stations (see Non-Patent Document 2, for example).

### PRIOR ART DOCUMENT

### Non-Patent Document

Non-Patent Document 1: 3GPP TR 38.804 V14.0.0(2017-03)
Non-Patent Document 2: 3GPP TS 37.340 V1.0.2(2017-09)

### SUMMARY OF THE INVENTION

### Problem to be Solved by the Invention

In LTE-NR dual connectivity, inter-modulation distortion (Inter-Modulation Distortion: IMD) and harmonics may occur in two or more uplink transmissions. In this case, the generated IMD and harmonics may fall on a downlink reception band of user equipment (User Equipment: UE) for an LTE component carrier or an NR component carrier, which may cause interference within the user equipment (in-device interference). In particular, since the NR system uses a wide bandwidth, such as a 28 GHz band, the NR system tends to be affected by the IMD.

Additionally, for dual connectivity between multiple radio communication systems to which respective different RATs are applied, which is not limited to the dual connectivity between the LTE system and the NR system, the following may occur: IMD caused by two or more uplink transmissions; falling of harmonics, etc., on a reception bandwidth; and in-device interference.

In view of the above-described problem, an object of the present invention is to provide a technique for performing communication that reduces an effect of in-device interference during dual connectivity executed by a radio communication system using a plurality of RATs.

### Means for Solving the Problem

According to the disclosed technology, there is provided user equipment for communicating with a base station apparatus, the user equipment including a generating unit that generates terminal capability information including information indicating an uplink band combination; information indicating whether simultaneous transmissions in the uplink band combination are allowed; and information indicating maximum sensitivity degradation when the simultaneous transmissions are executed in the uplink band combination; a transmitting unit that transmits the generated terminal capability information to the base station apparatus; and a receiving unit that receives an uplink scheduling allocation from the base station apparatus, wherein the user equipment executes the simultaneous transmissions in the uplink band combination based on the uplink scheduling allocation.

### Advantage of the Invention

According to the disclosed technique, communication can be executed that reduces an effect of in-device interference during dual connectivity executed in a radio communication system using a plurality of RATs.

### BRIEF DESCRIPTION OF DRAWINGS

FIG. 1 is a diagram illustrating inter-modulation distortion (IMD) during LTE-NR dual connectivity;

FIG. 2 is a diagram illustrating an example in which IMD occurs in a band combination of LTE-NR dual connectivity;

FIG. 3 is an example of a configuration of a radio communication system according to an embodiment of the present invention;

FIG. 4 is a sequence diagram according to an embodiment of the present invention, in which user equipment 200 performs capability reporting to a base station apparatus 100;

FIG. 5 is a diagram illustrating an example of a band combination in LTE-NR dual connectivity according to an embodiment of the present invention;

FIG. 6 is a diagram illustrating an example of MSD specified for a band combination according to an embodiment of the present invention;

FIG. 7 is a diagram illustrating an example of a capability report related to MSD according to an embodiment of the present invention;

FIG. 8 is a diagram illustrating an example of a functional configuration of the base station apparatus 100 according to an embodiment of the present invention;

FIG. 9 is a diagram illustrating an example of a functional configuration of the user equipment 200 according to an embodiment of the present invention;

FIG. 10 is a diagram illustrating an example of a hardware configuration of each of the user equipment 200 and the base station apparatus 100 according to an embodiment of the present invention;

FIG. 11 is a diagram illustrating an example of a capability report related to MSD according to a modified example 1; and

FIG. 12 is a diagram illustrating an example of a capability report message related to MSD according to the modified example 1.

### EMBODIMENTS OF THE INVENTION

In the following, embodiments of the present invention are described based on the drawings.

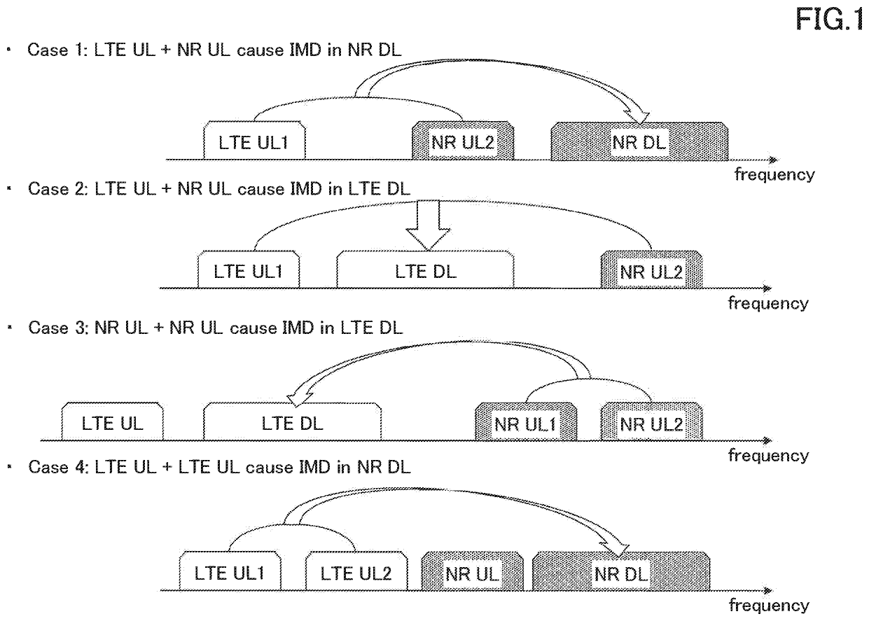

FIG. 1 is a diagram illustrating inter-modulation distortion (IMD) during LTE-NR dual connectivity.

In the following embodiment, a base station apparatus 100 and user equipment 200 are disclosed that support dual connectivity between multiple radio communication systems using respective different RATs, i.e., multi-RAT dual connectivity. Additionally, in the embodiment described below, in-device interference is described that is caused by inter-modulation distortion (IMD), harmonics, etc., in dual connectivity between an LTE system and an NR system (LTE-NR-dual connectivity). For LTE-NR dual connectivity, four typical cases can be considered in which in-device interference occurs, such as those illustrated in FIG. 1.

In Case 1, during uplink dual connectivity (LTE UL 1+NR UL 2) with an uplink carrier of an LTE system (LTE UL 1) and an uplink carrier of an NR system (NR UL 2), inter-modulation distortion caused by a combination of the LTE UL 1 and the NR UL 2 and/or harmonics caused by transmission of the LTE UL 1 or the NR UL 2 falls on a downlink carrier (NR DL) of the NR system to cause in-device interference in the NR DL.

In Case 2, during uplink dual connectivity (LTE UL 1+NR UL 2) with an uplink carrier of an LTE system (LTE UL 1) and an uplink carrier of an NR system (NR UL 2), inter-modulation distortion caused by a combination of the LTE UL 1 and the NR UL 2 and/or harmonics caused by transmission of the LTE UL 1 or the NR UL 2 falls on a downlink carrier (LTE DL) of the LTE system to cause in-device interference in the LTE DL.

In Case 3, during uplink dual connectivity (NR UL 1+NR UL 2) with two uplink carriers of an NR system (NR UL 1, NR UL 2), inter-modulation distortion caused by a combination of the NR UL 1 and the NR UL 2 and/or harmonics caused by transmission of the NR UL 1 or the NR UL 2 falls on a downlink carrier (LTE DL) of an LTE system to cause in-device interference in the LTE DL.

In Case 4, during uplink dual connectivity (LTE UL 1+LTE UL 2) with two uplink carriers of an LTE system (LTE UL 1, LTE UL 2), inter-modulation distortion caused by a combination of the LTE UL 1 and the LTE UL 2 and/or harmonics caused by transmission of the LTE UL 1 or the LTE UL 2 falls on a downlink carrier (NR DL) of an NR system to cause in-device interference in the NR DL.

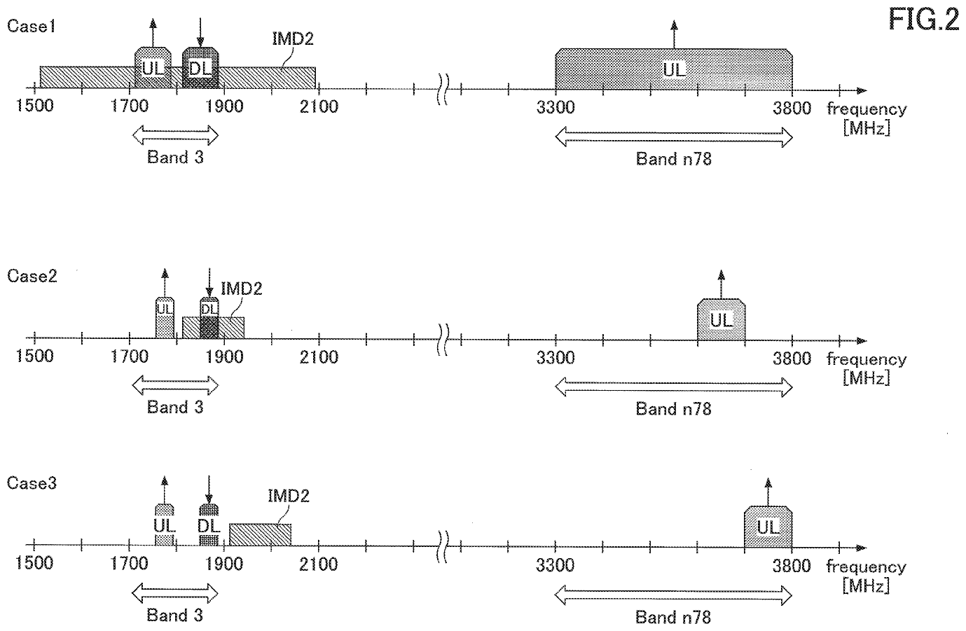

FIG. 2 is a diagram illustrating an example in which IMD occurs in a band combination of LTE-NR dual connectivity.

The band combination of the LTE-NR dual connectivity in Case 1 illustrated in FIG. 2 shows an example of UL (Uplink) 1710 MHz-1785 MHz and DL (Downlink) 1805 MHz-1880 MHz in LTE Band 3; and UL 3300 MHz-3800 MHz in NR Band n78. If, in Case 1, LTE UL and NR UL are simultaneously transmitted, second order inter-modulation distortion, i.e., IMD2, occurs in 1515 MHz-2095 MHz. As illustrated in Case 1, the IMD2 interferes with LTE DL.

Case 2 and Case 3 illustrated in FIG. 2 are examples in which IMD occurs when a channel band width is further specified in a band. The channel band width combination in the band combination of the LTE-NR dual connectivity in Case 2 shows an example of UL 1765 MHz-1785 MHz and DL 1860 MHz-1880 MHz in LTE Band 3 with the channel band widths of 20 MHz; and UL 3600 MHz-3800 MHz in NR Band n78 with the channel band width of 100 MHz. If, in Case 2, LTE UL and NR UL are simultaneously transmitted, IMD2 occurs in 1815 MHz-1935 MHz. As illustrated in Case 2, IMD2 interferes with LTE DL.

The channel band width combination in the band combination of the LTE-NR dual connectivity in Case 3 shows an example of UL 1765 MHz-1785 MHz and DL 1860 MHz-1880 MHz in LTE Band 3 with the channel band widths of 20 MHz; and UL 3700 MHz-3800 MHz in NR Band n78 with the channel band width of 100 MHz. If, in Case 3, LTE UL and NR UL are simultaneously transmitted, IMD2 occurs in 1915 MHz-2035 MHz. As illustrated in Case 3, IMD2 does not interfere with LTE DL.

### EMBODIMENTS

Embodiments are described below.

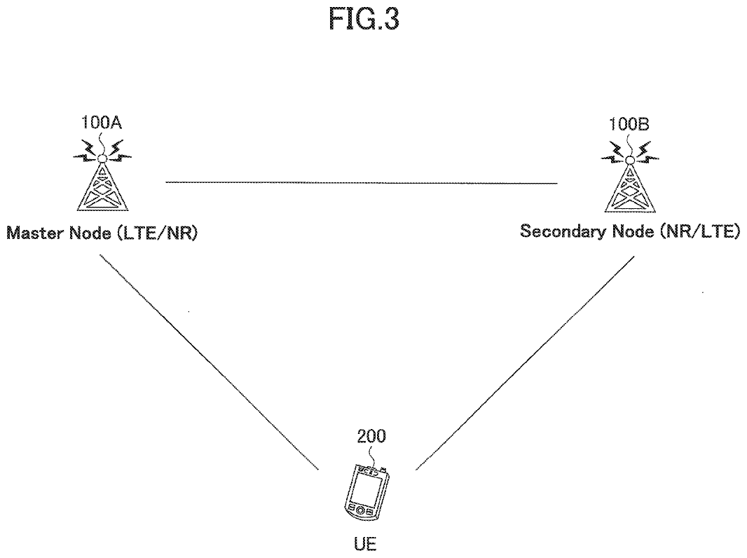

FIG. 3 is an example of a configuration of a radio communication system according to an embodiment of the present invention. FIG. 3 is a schematic diagram illustrating a radio communication system according to an embodiment of the present invention.

As illustrated in FIG. 3, user equipment 200 communicates with and is connected to a base station apparatus 100A and a base station apparatus 100B (which may be referred to, hereinafter, as “base station apparatus 100” when the base station apparatus 100A and the base station apparatus 100B are not to be distinguished from each other), which are provided by an LTE system and an NR system, and the user equipment 200 supports LTE-NR dual connectivity with the base station apparatus 100A, as a master base station, and the base station apparatus 100B, as a secondary base station. Namely, the user equipment 200 can execute simultaneous transmissions to the master base station apparatus 100A and the secondary base station apparatus 100B or simultaneous reception from the master base station apparatus 100A and the secondary base station apparatus 100B by simultaneously using a plurality of component carriers provided by the master base station apparatus 100A and the secondary base station apparatus 100B. Note that, in the depicted embodiment, the LTE system is provided with only one base station and the NR system is provided with only one base station. However, in general, a large number of base stations are located to cover service areas of the LTE system and the NR system.

Note that, in the following embodiments, LTE-NR dual connectivity is described. However, the user equipment according to the present disclosure is not limited to this. A person ordinarily skilled in the art will easily understand that the user equipment according to the present disclosure can be applied to dual connectivity between multiple radio communication systems using respective different RATs, i.e., multi-RAT dual connectivity.

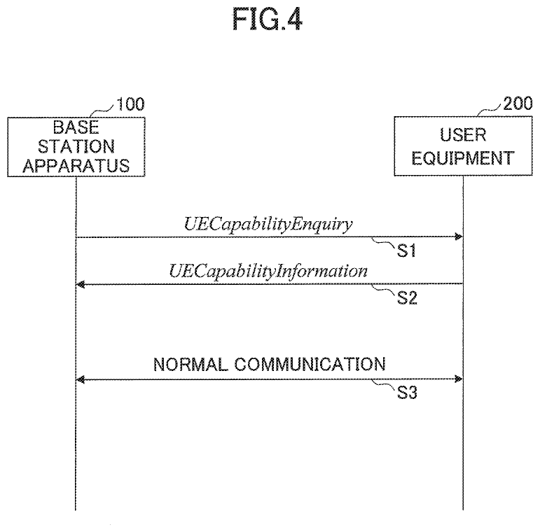

FIG. 4 is a sequence diagram according to an embodiment of the present invention, in which the user equipment 200 performs terminal capability reporting to the base station apparatus 100. In FIG. 4, the base station apparatus 100 transmits a terminal capability report request to the user equipment 200, and, in response to the terminal capability report request, the user equipment 200 transmits a terminal capability report to the base station apparatus 100.

At step S1, the base station apparatus 100 transmits, to the user equipment 200, an RRC (Radio Resource Control) message “UECapabilityEnquiry,” as the terminal capability report request. The UECapabilityEnquiry is used to obtain information related to radio access capability of the user equipment 200 through a network. The base station apparatus 100 is able to specify a type of radio access capability to be included in the information reported by the user equipment 200 by the UECapabilityEnquiry. For example, the base station apparatus 100 may request a radio access capability report of a band combination supported by the user equipment 200. The radio access capability on the band combination may include information indicating whether UL simultaneous transmissions in each band combination are allowed.

Subsequently, at step S2, the user equipment 200 transmits an RRC message “UECapabilityInformation” to the base station apparatus 100 as the terminal capability report. The UECapabilityInformation is used to report the information related to the radio access capability of the user equipment 200 to the network. Based on the UECapabilityEnquiry received by the user equipment 200 from the base station apparatus 100 at step S1, the user equipment 200 transmits, to the base station apparatus 100, the information related to the radio access capability supported by the user equipment 200.

At step S3, the base station apparatus 100 executes normal communication adopted to the terminal capability according to the UECapabilityInformation received from the user equipment 200 at step S2. For example, when the UECapabilityInformation received from the user equipment 200 at step S2 includes information indicating supported band combinations and information indicating whether UL simultaneous transmissions are allowed, the base station apparatus 100 executes scheduling within a range of the supported band combinations. When UL simultaneous transmissions are allowed, the base station apparatus 100 may execute scheduling for causing the user equipment 200 to execute UL simultaneous transmissions.

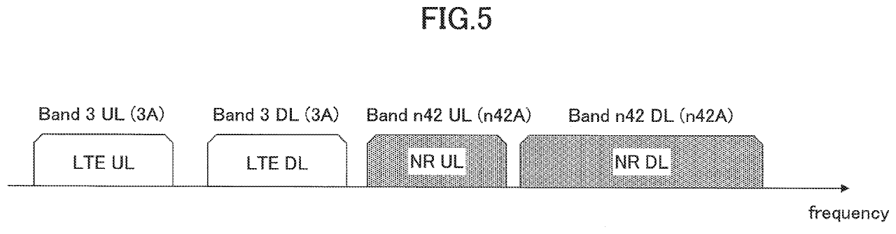

FIG. 5 is a diagram illustrating an example of a band combination of LTE-NR dual connectivity according to an embodiment of the present invention. In FIG. 5, an example of a band combination during LTE-NR dual connectivity is shown, and, at the same time, reporting of the band combination and terminal capability related to UL simultaneous transmissions from the user equipment 200 to the base station apparatus 100 is described.

A UL band combination in LTE-NR dual connectivity is defined as follows. For example, the UL band combination “UL 3A+n42A” shown in FIG. 5 is defined to support 1 CC (Carrier Component) and a 20 MHz width in Band 3 in 1.7 GHz band of LTE and 1 CC and a 20 MHz width in Band n42 in a 3.5 GHz band of NR. Support of 1 CC and a 20 MHz width is indicated by the “A” included in 3A or n42A, which shows that a CA BW class A (Carrier aggregation bandwidth class A) is supported. Here, the CA BW class A may indicate that 1 CC and a bandwidth less than or equal to 20 MHz width is supported. Note that, similar to UL, a DL band combination “DL 3A+n42A” may be defined for DL.

Here, when a UL band combination of LTE-NR dual connectivity is reported from the user equipment 200 to the base station apparatus 100 as terminal capability, i.e., as UE capability, the base station apparatus 100 may determine that the user equipment 200 is capable of UL simultaneous transmissions in the UL band combination. When UL simultaneous transmissions are allowed in the UL band combination, the user equipment 200 may configure the UL band combination of the LTE-NR dual connectivity for UE capability, and the user equipment 200 may report the UE capability to the base station apparatus 100. For example, when “UL 3A+n42A” illustrated in FIG. 5 is reported from the user equipment 200 to the base station apparatus 100, LTE UL 3A and NR UL n42A can be simultaneously transmitted from the user equipment 200, so that information explicitly indicating that simultaneous transmissions are allowed may not be reported.

If, in addition to the UL band combination of LTE-NR dual connectivity, a bit indicating (one bit indicator) that terminal capability “single Tx UE” is supported is reported as the UE capability, the base station apparatus 100 may determine that the user equipment 200 may execute UL transmission with a CC in one band of the UL band combination. Namely, if UL transmission with a CC in one band of the UL band combination is allowed, the user equipment 200 may configure a UL band combination of LTE-NR dual connectivity and a bit indicating that single Tx UE is supported for the UE capability, and the user equipment 200 may transmit the UE capability to the base station apparatus 100. For example, when “UL 3A+n42A” shown in FIG. 5 and a bit indicating that single Tx UE is supported are transmitted from the user equipment 200 to the base station apparatus 100, the user equipment 200 can execute UL transmission in a CC of one band in UL 3A of LTE or UL n42A of NR, i.e., the user equipment 200 can execute UL transmission in UL 3A of LTE or UL n42A of NR.

If, in addition to a UL band combination of LTE-NR dual connectivity, a bit (one bit indicator) indicating that terminal capability “simultaneous transmissions in the UL band combination are disallowed” is transmitted as the UE capability, the base station apparatus 100 may determine that the user equipment 200 is unable to execute UL simultaneous transmissions in the UL band combination. Namely, when the user equipment 200 is unable to execute UL simultaneous transmissions in the UL band combination, the user equipment 200 may configure a UL band combination in LTE-NR dual connectivity and a bit indicating that simultaneous transmissions are disallowed in the UL band combination for the UE capability, and the user equipment 200 may transmit the UE capability to the base station apparatus 100. For example, if “UL 3A+n42A” illustrated in FIG. 5 and a bit indicating that simultaneous transmissions are disallowed in the UL band combination are reported from the user equipment 200 to the base station apparatus 100, the user equipment 200 is unable to execute UL simultaneous transmissions in UL 3A of LTE and UL n42A of NR. However, instead of simultaneous transmissions, time division is applied, and UL transmission in UL 3A of LTE or UL transmission in UL n42A of NR is allowed.

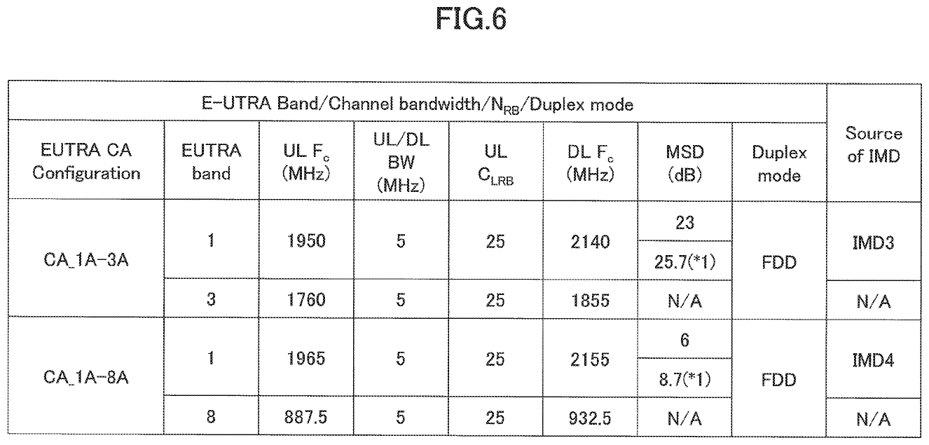

FIG. 6 is a diagram illustrating an example of MSD specified for a band combination according to an embodiment of the present invention. FIG. 6 shows an example in which Maximum Sensitivity Degradation (MSD) is specified for a CA band combination of LTE. MSD is a value indicating a maximum extent in degradation of reception sensitivity in an interfered band when simultaneous transmissions are performed in a specific band combination.

When the EUTRA band is “1” for the CA band combination “CA_1A-3A,” MSD is “23” dB or “25.7” dB, and IMD3, which is third order inter-modulation distortion, is a source of interference. The (*1) added to “25.7” dB is MSD applied to a case in which four antenna ports are used. When the EUTRA band is “3,” MSD is N/A (Not Applicable). Namely, it indicates that no interference is caused by IMD.

Note that “UL F_{c} (MHz)” indicates a center frequency of a UL band, “UL/DL BW (MHz)” indicates a band width of a UL band or a DL band, “UL C_{LRB}” indicates a number of resource blocks, “DL Fe” indicates a center frequency of a DL band, and “Duplex mode” indicates a duplex mode.

Furthermore, when EUTRA band is “1” in the CA band combination “CA_1A-8A,” MSD is “6” dB or “8.7” dB, and IMD4, which is fourth order inter-modulation distortion, is a source of interference. The (*1) added to “8.7” dB indicates that MSD is applied to a case in which four antenna ports are used in the user equipment 200. When EUTRA band is “8,” MSD is N/A (Not Applicable). Namely, it indicates that no interference is caused by IMD.

Here, for each UL band combination of LTE-NR dual connectivity, the user equipment 200 may report, to the base station apparatus 100, MSD for each DL band, as the terminal capability. For example, in FIG. 6, for “CA_1A-3A,” the user equipment 200 may report, to the base station apparatus 100, information indicating that MSD is “23” or “25.7,” as terminal capability. The base station apparatus 100 executes appropriate scheduling based on the received MSD.

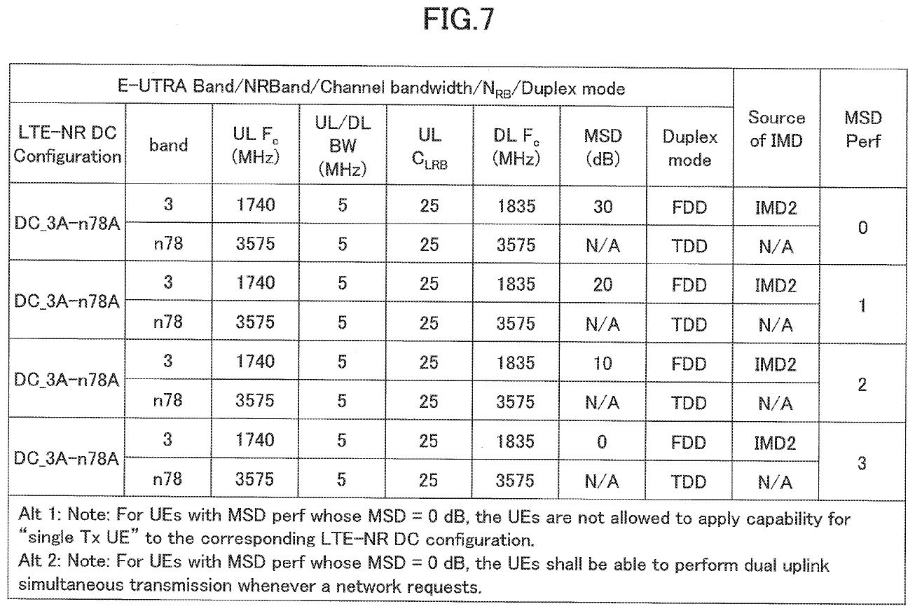

FIG. 7 is a diagram illustrating an example of a capability report related to MSD according to an embodiment of the present invention. For band combinations of UL LTE-NR dual connectivity and DL LTE-NR dual connectivity, the user equipment 200 may report, for each band combination, a bitmap with a predetermined length to the base station apparatus 100. When a predetermined bit in the bitmap is configured to be TRUE, the base station apparatus 100 may execute scheduling based on a predetermined condition on MSD corresponding to the bit. The bitmap with the predetermined length may represent a numerical value.

In FIG. 7, any one of four types of LTE-NR DC Configurations is “DC_3A-n78A.” Here, DC represents dual connectivity. In the band combination “DC_3A-n78A” illustrated in FIG. 7, Band 3, which is 1.7 GHz band of LTE, supports 1 CC and 5 MHz width, a number of resource blocks is 25, a center frequency in a UL band is 1740 MHz, a center frequency of a DL band is 1835 MHz, and a duplex method is FDD. In the band combination “DC_3A-n78A” illustrated in FIG. 7, Band n78, which is a 3.5 GHz band of NR, supports 1 CC and 5 MHz width, a number of resource blocks is 25, a center frequency of a UL band is 3575 MHz, a center frequency of a DL band is 3575 MHz, and a duplex method is TDD. In each “DC_3A-n78A,” MSD is N/A for band n78, and no interference is caused by IMD.

In contrast, for Band 3, different MSDs are defined for four types of band combinations “DC_3A-n78A,” respectively. As illustrated in FIG. 7, MSD of 30 dB, 20 dB, 10 dB, and 0 dB are defined for the respective band combinations. Furthermore, information “MSD Perf” to be reported from the user equipment 200 to the base station apparatus 100 is defined to be “0” for the band combination with MSD of 30 dB; “1” for the band combination with MSD of 20 dB; “2” for the band combination with MSD of 10 dB, and “3” for the band combination with MSD of 0 dB. Note that, in each band combination, a source of interference is IMD2, which is second order inter-modulation distortion.

Note that, “Alt1” in FIG. 7 indicates that, to the user equipment 200 for which MSD is 0 dB in the LTE-NR DC Configuration, the terminal capability “single Tx UE” described in FIG. 6 is not applied. Additionally, “Alt2” in FIG. 7 indicates that the user equipment 200 for which MSD is 0 dB in the LTE-NR DC Configuration executes UL simultaneous transmissions, upon receiving a request from the network.

In the following, an example of reporting of terminal capability using “MSD Perf” illustrated in FIG. 7 is described. As an assumption, suppose that the user equipment 200 supports UL dual transmissions (simultaneous transmissions) and UL single transmission in the band combination “DC_3A-n78A.”

For example, when implementation performance of the user equipment 200 is favorable and almost no IMD2 is generated, i.e., when MSD can be deemed to be 0 dB, the user equipment 200 reports, to the base station apparatus 100, UECapabilityInformation in which “MSD Perf” is set to “3.” In contrast, when implementation performance of the user equipment 200 is unfavorable and relatively large IMD2 is generated, for example, when the user equipment 200 can satisfy MSD of only 30 dB, the user equipment 200 reports, to the base station apparatus 100, UECapabilityInformation in which “MSD Perf” is set to “0.”

The base station apparatus 100 can determine an interference condition on DL in Band 3 by “MSD Perf” reported from the user equipment 200 and can perform appropriate scheduling.

In the above-described embodiment, the user equipment 200 transmits, to the base station apparatus 100, a band combination formed of an LTE band and an NR band, as terminal capability, i.e., UECapabilityInformation during multi-RAT dual connectivity in which different RATs are used, and thereby the base station apparatus 100 can obtain information on terminal capability related to multi-RAT dual connectivity of the user equipment 200.

Furthermore, when a UL band combination of LTE-NR dual connectivity is reported by UECapabilityInformation, the base station apparatus 100 can obtain information representing that the user equipment 200 supports UL simultaneous transmissions in the UL band combination.

Furthermore, when a UL band combination of LTE-NR dual connectivity and terminal capability “single Tx UE” are reported by UECapabilityInformation, the base station apparatus 100 can obtain information indicating that the user equipment 200 executes transmission with 1 CC in one band in the UL band combination.

Furthermore, when a UL band combination of LTE-NR dual connectivity and terminal capability “simultaneous transmissions are disallowed for the band combination” are reported by UECapabilityInformation, the base station apparatus 100 can obtain information representing that the user equipment 200 is unable to execute simultaneous transmissions in the UL band combination.

As described above, by reporting, by the user equipment 200, whether UL simultaneous transmissions are allowed in the UL band combination to the base station apparatus 100, the base station apparatus 100 can perform scheduling in which an effect of IMD to DL is considered when the base station apparatus 100 executes UL simultaneous transmissions.

Furthermore, when a UL band combination of LTE-NR dual connectivity is reported and terminal capability “MSD Perf” is reported by UECapabilityInformation, the base station apparatus 100 can obtain information representing MSD when the user equipment 200 executes UL simultaneous transmissions in the UL band combination. By receiving, by the base station apparatus 100, the above-described UECapabilityInformation, the base station apparatus 100 can have knowledge of an extent of interference caused by IMD on a DL band when the user equipment 200 executes UL simultaneous transmissions, so that the base station apparatus 100 can perform scheduling with which an effect of IMD tends not to be received by selecting UL dual transmissions or UL single transmission.

Namely, communication can be executed such that an effect of in-device interference can be reduced during dual connectivity executed between multiple radio communication systems using respective different RATs.

(Device Configuration)

Next, examples of functional configurations of the base station apparatus 100 and the user equipment 200, which perform the process and the operation described above, are described. Each of the base station apparatus 100 and the user equipment 200 includes a function for implementing at least the embodiments. However, each of the base station apparatus 100 and the user equipment 200 may only include a part of the function of the embodiments.

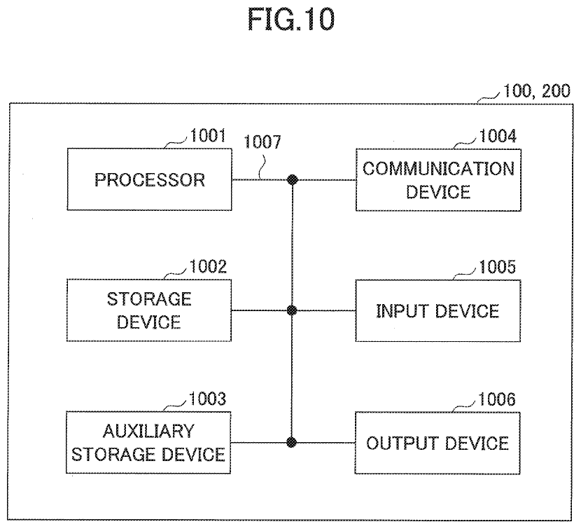

FIG. 7 is a diagram illustrating an example of a functional configuration of the base station apparatus 100. As illustrated in FIG. 7, the base station apparatus 100 includes a transmitting unit 110; a receiving unit 120; a configuration information management unit 130; and a terminal capability management unit 140. The functional configuration illustrated in FIG. 10 is merely an example. The functional division and names of the functional units may be any division and names, provided that the operation according to the embodiments of the present invention can be executed.

The transmitting unit 110 includes a function for generating signals to be transmitted to the user equipment 200 and for wirelessly transmitting the signals. The receiving unit 120 includes a function for receiving various types of signals transmitted from the user equipment 200 and for retrieving, for example, higher layer information from the received signals. Additionally, the transmitting unit 110 is provided with a function for transmitting, to the user equipment 200, PSS or NR-PSS, SSS or NR-SSS, PBCH or NR-PBCH, DL/UL control signals, etc. Additionally, the transmitting unit 110 transmits, to the user equipment 200, a message for requesting a terminal capability report, and information indicating UL or DL scheduling, and the receiving unit 120 receives, from the user equipment 200, a message related to a terminal capability report.

The configuration information management unit 130 stores preconfigured configuration information and various types of configuration information to be transmitted to the user equipment 200. Content of the configuration information is, for example, information related to a band combination, information related to terminal capability, etc.

The terminal capability management unit 140 performs control, in the base station apparatus 100, for transmitting a terminal capability report request message, for example, UECapabilityEnquiry, to the user equipment 200, and performs control of receiving the terminal capability report from the user equipment 200 and executing communication in accordance with the terminal capability, which are described in the embodiments.

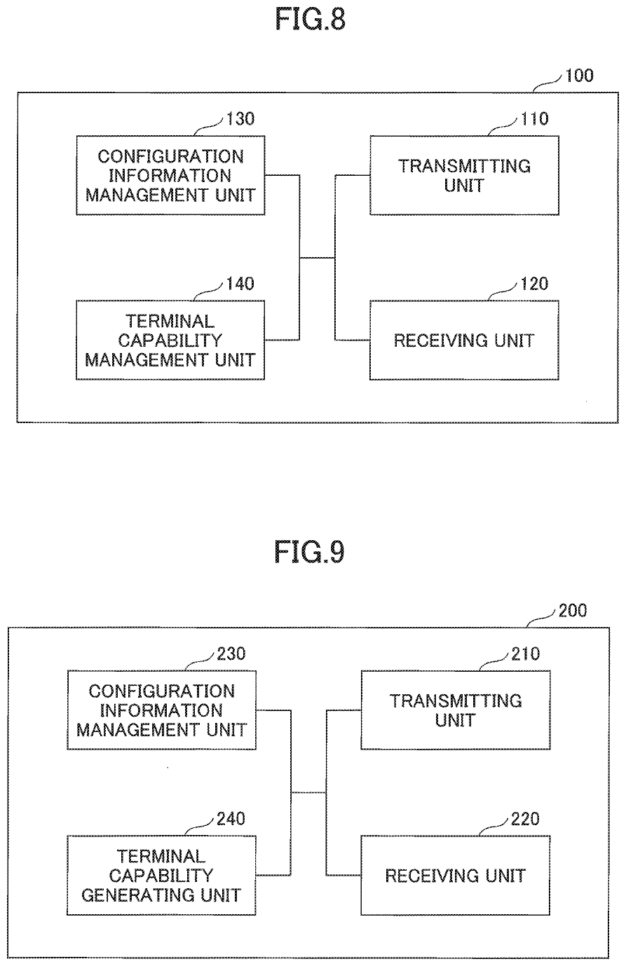

FIG. 8 is a diagram illustrating an example of a functional configuration of the user equipment 200. As illustrated in FIG. 8, the user equipment 200 is provided with a transmitting unit 210; a receiving unit 220; a configuration information management unit 230; and a terminal capability generating unit 240. The functional configuration illustrated in FIG. 8 is merely an example. The functional division and the names of the functional units may be any division and names, provided that the operation according to the embodiments of the present invention can be executed.

The transmitting unit 210 generates transmission signals from transmission data, and wirelessly transmits the transmission signals. The receiving unit 220 receives various types of signals through radio, and retrieves higher layer signals from the received physical layer signals. Additionally, the receiving unit 220 is provided with a function for receiving PSS or NR-PSS, SSS or NR-SSS, PBCH or NR-PBCH, DL/UL control signals, etc., which are transmitted from the base station apparatus 100. Additionally, the transmitting unit 210 transmits, to the base station apparatus 100, a terminal capability report message, and the receiving unit 220 receives, from the base station apparatus 100, a message related to a terminal capability report request and information indicating UL or DL scheduling.

The configuration information management unit 230 stores various types of configuration information received from the base station apparatus 100 by the receiving unit 220. Additionally, the configuration information management unit 230 stores preconfigured configuration information. The content of the configuration information is, for example, information related to a band combination, information related to a terminal capability report, etc.

The terminal capability generating unit 240 performs control related to generation and transmission of a terminal capability report message, for example, UECapabilityInformation, to be transmitted from the user equipment 200 to the base station apparatus 100, which is described in the embodiments. Note that a functional unit related to transmission, etc., of the terminal capability report message in the terminal capability generating unit 240 may be included in the transmitting unit 210, and a functional unit related to reception, etc., of a terminal capability report request message in the terminal capability generating unit 240 may be included in the receiving unit 220.

(Hardware Configuration)

The functional configuration diagrams (FIG. 7 and FIG. 8) used for describing the above-described embodiments of the present invention show blocks of functional units. These functional blocks (components) are implemented by any combination of hardware and/or software. Additionally, means for implementing each functional block is not particularly limited. Namely, each functional block may be implemented by a single device in which a plurality of elements is physically and/or logically coupled, or each functional block may be implemented by a plurality of devices, while directly and/or indirectly (e.g., wired and/or wireless) connecting two or more devices that are physically and/or logically separated.

For example, each of the base station apparatus 100 and the user equipment 200 in the embodiments of the present invention may function as a computer that performs processing according to the embodiments of the present invention. FIG. 9 is a diagram illustrating an example of a hardware configuration of a radio communication device, which may be the base station apparatus 100 or the user equipment 200 according to the embodiments of the present invention. Each of the above-described base station apparatus 100 and the user equipment 200 may be physically configured as a computer device including a processor 1001; a storage device 1002; an auxiliary storage device 1003; a communication device 1004; an input device 1005; an output device 1006; a bus 1007, etc.

Note that, in the following description, the term “apparatus” can be read as a circuit, a device, a unit, etc. The hardware configuration of each of the base station apparatus 100 and the user equipment 200 may be configured to include one or more of the respective devices indicated by 1001 through 1006 in the figure, or may be configured not to include a part of the devices.

Each function of the base station apparatus 100 and the user equipment 200 is implemented by loading predetermined software (program) on hardware, such as the processor 1001 and the storage device 1002, so that the processor 1001 performs computation and controls communication by the communication device 1004, and reading and/or writing of data in the storage device 1002 and the auxiliary storage device 1003.

The processor 1001, for example, operates an operating system to control the entire computer. The processor 1001 may be configured with a central processing unit (CPU: Central Processing Unit) including an interface with a peripheral device, a control device, a processing device, a register, etc.

Additionally, the processor 1001 reads a program (program code), a software module and data from the auxiliary storage device 1003 and/or the communication device 1004 to the storage device 1002, and executes various processes according to these. As the program, a program is used which causes a computer to execute at least a part of the operations described in the above-described embodiment. For example, the transmitting unit 110, the receiving unit 120, the configuration information management unit 130, and the terminal capability management unit 140 of the base station apparatus 100 illustrated in FIG. 7 may be implemented by a control program stored in the storage device 1002 and executed by the processor 1001. Furthermore, for example, the transmitting unit 210, the receiving unit 220, the configuration information management unit 230, and the terminal capability generating unit 240 of the user equipment 200 illustrated in FIG. 8 may be implemented by a control program stored in the storage device 1002 and executed by the processor 1001. Although it is described that the above-described various processes are executed by a single processor 1001, the above-described various processes may be simultaneously or sequentially executed by two or more processors 1001. The processor 1001 may be implemented by one or more chips. Note that the program may be transmitted from a network via an electric communication line.

The storage device 1002 is a computer readable recording medium, and the storage device 1002 may be formed of at least one of a read-only memory (ROM), an erasable programmable ROM (EPROM), an electrically erasable programmable ROM (EEPROM), a random access memory (RAM), etc. The storage device 1002 may be referred to as a register, a cache, a main memory (main storage device), etc. The storage device 1002 can store programs (program codes), software modules, etc., that can be executed to perform the process according to the embodiments of the present invention.

The auxiliary storage device 1003 is a computer readable recording medium, and, for example, the auxiliary storage device 1003 may be formed of at least one of an optical disk such as a CD-ROM (Compact Disc ROM), a hard disk drive, a flexible disk, a magneto-optical disk (for example, a compact disk, a digital versatile disk, a Blu-ray (registered trademark) disk), a smart card, a flash memory (for example, a card, a stick, a key drive), a floppy (registered trademark) disk, a magnetic strip, etc. The auxiliary storage device 1003 may be referred to as an auxiliary storage device. The above-described storage medium may be, for example, a database including the storage device 1002 and/or the auxiliary storage device 1003, a server, or any other suitable medium.

The communication device 1004 is hardware (transmission/reception device) for performing communication between computers via a wired and/or wireless network, and, for example, the communication device 1004 is also referred to as a network device, a network controller, a network card, a communication module, etc. For example, the transmitting unit 110 and the receiving unit 120 of the base station apparatus 100 may be implemented by the communication device 1004. Additionally, the transmitting unit 210 and the receiving unit 220 of the user equipment 200 may be implemented by the communication device 1004.

The input device 1005 is an input device (e.g., a keyboard, a mouse, a microphone, a switch, a button, a sensor, etc.) for receiving an input from outside. The output device 1006 is an output device (e.g., display, speaker, LED lamp, etc.) that performs output toward outside. Note that the input device 1005 and the output device 1006 may be integrated (for example, a touch panel).

Furthermore, the devices, such as the processor 1001 and the storage device 1002, are connected by a bus 1007 for communicating information. The bus 1007 may be formed of a single bus, or the bus 1007 may be formed of buses that are different among the devices.

Furthermore, each of the base station apparatus 100 and the user equipment 200 may be configured to include hardware, such as a microprocessor, a digital signal processor (DSP: Digital Signal Processor), an ASIC (Application Specific Integrated Circuit), a PLD (Programmable Logic Device), an FPGA (Field Programmable Gate Array), etc., and a part or all of the functional blocks may be implemented by the hardware. For example, the processor 1001 may be implemented by at least one of these hardware components.

### Modified Example 1

In the following, another example of an operation performed by the radio communication system is described as a modified example 1. In the modified example 1, the user equipment UE communicates with, by DC, a base station gNB that provides one or more NR cells and a base station eNB that provides one or more LTE cells.

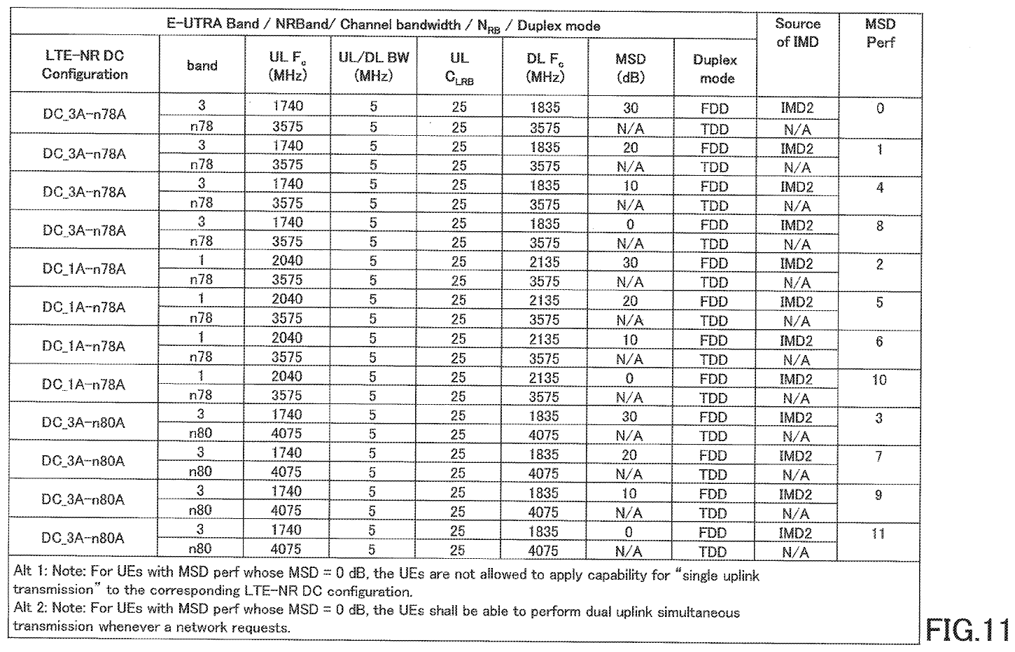

FIG. 11 is a diagram illustrating an example of a capability report related to MSD according to the modified example 1. FIG. 11 is a diagram illustrating an example of a capability report related to MSD according to an embodiment of the present invention. For a plurality of band combinations of UL LTE-NR dual connectivity and DL LTE-NR dual connectivity, the user equipment 200 may reports bitmaps with predetermined lengths to the base station apparatus 100. Based on a band combination corresponding to a predetermined bit in a bitmap and a predetermined condition on MSD, the base station apparatus 100 may perform scheduling. The bitmap with the predetermined length may represent a numerical value.

In FIG. 11, LTE-NR DC Configuration includes four types of “DC_3A-n78A,” four types of “DC_1A-n78A,” and four types of “DC_3A-n80A.” Note that DC represents dual connectivity. In the band combination “DC_3A-n78A” illustrated in FIG. 11, Band 3, which is 1.7 GHz band of LTE, supports 1 CC and 5 MHz width, a number of resource blocks is 25, a center frequency in a UL band is 1740 MHz, a center frequency of a DL band is 1835 MHz, and a duplex method is FDD. In the band combination “DC_3A-n78A” illustrated in FIG. 11, Band n78, which is a 3.5 GHz band of NR, supports 1 CC and 5 MHz width, a number of resource blocks is 25, a center frequency of a UL band is 3575 MHz, a center frequency of a DL band is 3575 MHz, and a duplex method is TDD. In each “DC_3A-n78A,” MSD is N/A for band n78, and no interference is caused by IMD.

In contrast, for band 3, different MSDs are defined for four types of band combinations “DC_3A-n78A,” respectively. As illustrated in FIG. 11, MSD of 30 dB, 20 dB, 10 dB, and 0 dB are defined for the respective band combinations. Furthermore, information “MSD Perf” to be reported from the user equipment 200 to the base station apparatus 100 is defined to be “0” for the band combination with MSD of 30 dB; “1” for the band combination with MSD of 20 dB; “4” for the band combination with MSD of 10 dB, and “8” for the band combination with MSD of 0 dB. Note that, in each band combination, a source of interference is IMD2, which is second order inter-modulation distortion.

In the band combination “DC_1A-n78A” illustrated in FIG. 11, Band 1, which is 2.0 GHz band of LTE, supports 1 CC and 5 MHz width, a number of resource blocks is 25, a center frequency in a UL band is 2040 MHz, a center frequency of a DL band is 2135 MHz, and a duplex method is FDD. In the band combination “DC_1A-n78A” illustrated in FIG. 11, Band n78, which is a 3.5 GHz band of NR, supports 1 CC and 5 MHz width, a number of resource blocks is 25, a center frequency of a UL band is 3575 MHz, a center frequency of a DL band is 3575 MHz, and a duplex method is TDD. In each “DC_31-n78A,” MSD is N/A for band n78, and no interference is caused by IMD.

In contrast, for band 1, different MSDs are defined for four types of band combinations “DC_1A-n78A,” respectively. As illustrated in FIG. 11, MSD of 30 dB, 20 dB, 10 dB, and 0 dB are defined for the respective band combinations. Furthermore, information “MSD Perf” to be reported from the user equipment 200 to the base station apparatus 100 is defined to be “2” for the band combination with MSD of 30 dB; “5” for the band combination with MSD of 20 dB; “6” for the band combination with MSD of 10 dB, and “10” for the band combination with MSD of 0 dB. Note that, in each band combination, a source of interference is IMD2, which is second order inter-modulation distortion.

In the band combination “DC_3A-n80A” illustrated in FIG. 11, Band 3, which is 1.7 GHz band of LTE, supports 1 CC and 5 MHz width, a number of resource blocks is 25, a center frequency in a UL band is 1740 MHz, a center frequency of a DL band is 1835 MHz, and a duplex method is FDD. In the band combination “DC_3A-n80A” illustrated in FIG. 11, Band n80, which is a 4.0 GHz band of NR, supports 1 CC and 5 MHz width, a number of resource blocks is 25, a center frequency of a UL band is 4075 MHz, a center frequency of a DL band is 4075 MHz, and a duplex method is TDD. In each “DC_3A-n80A,” MSD is N/A for band n80, and no interference is caused by IMD.

In contrast, for band 3, different MSDs are defined for four types of band combinations “DC_3A-n80A,” respectively. As illustrated in FIG. 11, MSD of 30 dB, 20 dB, 10 dB, and 0 dB are defined for the respective band combinations. Furthermore, information “MSD Perf” to be reported from the user equipment 200 to the base station apparatus 100 is defined to be “3” for the band combination with MSD of 30 dB; “7” for the band combination with MSD of 20 dB; “9” for the band combination with MSD of 10 dB, and “11” for the band combination with MSD of 0 dB. Note that, in each band combination, a source of interference is IMD2, which is second order inter-modulation distortion.

Note that, similar to FIG. 7, “Alt1” in FIG. 11 indicates that, to the user equipment 200 for which MSD is 0 dB in the LTE-NR DC Configuration, the terminal capability “single Tx UE” described in FIG. 6 is not applied. Additionally, similar to FIG. 7, “Alt2” in FIG. 11 indicates that the user equipment 200, for which MSD is 0 dB in the LTE-NR DC Configuration, executes UL simultaneous transmissions, upon receiving a request from the network.

In the following, an example of reporting of terminal capability using “MSD Perf” illustrated in FIG. 11 is described. As an assumption, suppose that the user equipment 200 supports UL dual transmissions (simultaneous transmissions) and UL single transmission in the band combination “DC_3A-n78A,” “DC_1A-n78A,” or “DC_3A-n80A.”

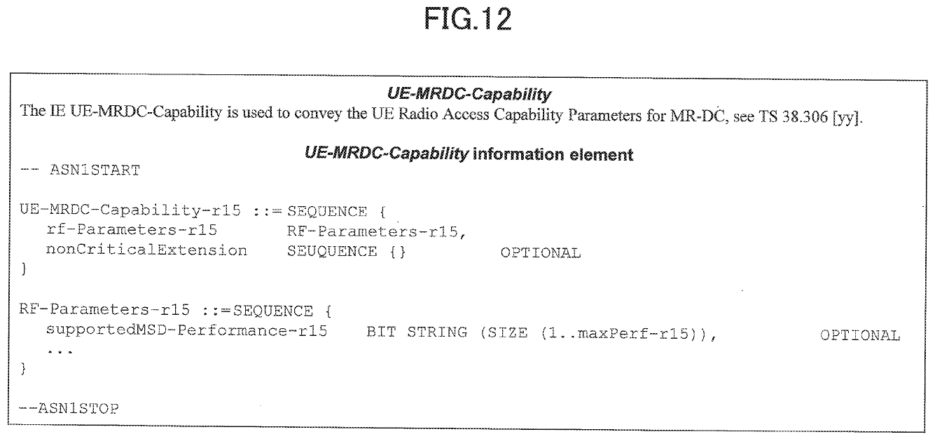

FIG. 12 is a diagram illustrating an example of a capability report message related to MSD according to the modified example 1. As illustrated in FIG. 12, information element “UE-MRDC-Capability” reports radio access capability of the user equipment 200 related to MR-DC to the base station apparatus 100. The “UE-MRDC-Capability” includes an information element “rf-Parameters-r15” including a parameter related to radio access. Additionally, “rf-Parameters-r15” includes information element “supportedMSD-Performance-r15.” The “supportedMSD-Performance-r15” is a bitmap from 1 to maxPerf or a numerical value, and “supported MSD-Performance-r15” corresponds to capability related to a band combination and IMD illustrated in FIG. 11, which correspond to the bitmap or the numerical value. For example, when “supportedMSD-Performance-r15” is “6,” the “supportedMSD-Performance-r15” indicates that interference caused by IMD2, for which MSD is 10 dB, occurs in Band 1 of the band combination “DC_1A-n78A.” Additionally, for example, when “supportedMSD-Performance-r15” is “11,” the “supportedMSD-Performance-r15” indicates that MSD is 0 dB in Band 3 in the band combination “DC_3A-n80A,” and that there is no need to consider interference caused by IMD2.

Note that one “supportedMSD-Performance-r15” may be reported to each unit of the user equipment 200, or a plurality of “supportedMSD-Performance-r15” may be reported to each unit of the user equipment 200. The capability related to MSD indicated by “supported MSD-performance-r15” corresponds to one or more band combinations, and the band combination may be freely configured.

Return to FIG. 11. For example, when implementation performance of the user equipment 200 is favorable and almost no IMD2 occurs, i.e., when MSD can be deemed to be 0 dB, the user equipment 200 reports, to the base station apparatus 100, UECapabilityInformation in which “MSD Perf” illustrated in FIG. 12 is set to “8,” “10,” or “11.” In contrast, when implementation performance of the user equipment 200 is unfavorable and relatively large IMD2 occurs, for example, when the user equipment 200 can satisfy MSD of only 30 dB, the user equipment 200 reports, to the base station apparatus 100, UECapabilityInformation in which “MSD Perf” illustrated in FIG. 12 is set to “0,” “2,” or “3.”

The base station apparatus 100 can determine an interference condition on a DL band of LTE-NR DC Configuration, such as Band 3 or Band 1 in the example illustrated in FIG. 11, by “MSD Perf” related to multiple band combinations that is reported from the user equipment 200 and can perform appropriate scheduling.

In the above-described modified example 1, the user equipment 200 transmits, to the base station apparatus 100, a band combination formed of an LTE band and an NR band, as terminal capability, i.e., UECapabilityInformation during multi-RAT dual connectivity in which different RATs are used, and thereby the base station apparatus 100 can obtain information on terminal capability related to multi-RAT dual connectivity of the user equipment 200.

Furthermore, when a UL band combination of LTE-NR dual connectivity and terminal capability “MSD Perf” are reported by UECapabilityInformation, the base station apparatus 100 can obtain information indicating MSD when the user equipment 200 executes UL simultaneous transmissions in a plurality of UL band combinations. By receiving the above-described UECapabilityInformation, the base station apparatus 100 can have knowledge of a degree of interference on a DL band caused by IMD when the user equipment 200 executes UL simultaneous transmissions, so that the base station apparatus 100 can perform scheduling with which an effect of IMD tends not to be received by appropriately selecting UL dual transmissions or UL single transmission.

Namely, communication can be executed such that an effect of in-device interference can be reduced during dual connectivity executed between multiple radio communication systems using respective different RATs.

### Conclusion of the Embodiments

As described above, according to the embodiments of the present invention, there is provided user equipment for communicating with a base station apparatus, the user equipment including a generating unit that generates terminal capability information including information indicating an uplink band combination; information indicating whether simultaneous transmissions in the uplink band combination are allowed; and information indicating maximum sensitivity degradation when the simultaneous transmissions are executed in the uplink band combination; a transmitting unit that transmits the generated terminal capability information to the base station apparatus; and a receiving unit that receives an uplink scheduling allocation from the base station apparatus, wherein the user equipment executes the simultaneous transmissions in the uplink band combination based on the uplink scheduling allocation.

With the above-described configuration, the base station apparatus 100 can perform, by receiving MSD when the simultaneous transmissions are executed in the uplink band combination, scheduling in which an effect of IMD tends not to be received, and the user equipment 200 can perform uplink simultaneous transmissions in which an effect of in-device interference is reduced, based on the scheduling.

The terminal capability information may include only one item of the information indicating the maximum sensitivity degradation in the user equipment. With this configuration, the user equipment 200 can collectively report, to the base station apparatus 100, MSD for a case in which simultaneous transmissions are executed in an uplink band combination.

The information indicating the maximum sensitivity degradation may be included in the terminal capability information including information indicating maximum sensitivity degradation when the user equipment executes simultaneous transmissions in each of corresponding one or more uplink band combinations. With this configuration, the user equipment 200 can report, to the base station apparatus 100, MSD for a case in which simultaneous transmissions are performed in the uplink band combination.

The uplink band combination may be associated with a plurality of items of information representing the maximum sensitivity degradation, and, for each uplink band combination, information indicating one of the plurality of items of the information representing the maximum sensitivity gradation may be included in the terminal capability information. With this configuration, the user equipment 200 can selectively report, to the base station apparatus 100, MSD for a case in which simultaneous transmissions are performed in an uplink band combination.

When simultaneous transmissions are allowed in a first uplink band combination, the user equipment may implicitly report, to the base station apparatus, that the simultaneous transmissions are allowed by not including information indicating whether the simultaneous transmissions in the first uplink band combination are allowed in the terminal capability information, and, when simultaneous transmissions are disallowed in a second uplink band combination, the user equipment may include information indicating that the simultaneous transmissions are not allowed in the second uplink band combination in the terminal capability information. With this configuration, when capability related to a UL band combination of LTE-NR dual connectivity is reported by the terminal capability information or implicit reporting, the base station apparatus 100 can perform scheduling by obtaining the information indicating that the user equipment 200 supports UL simultaneous transmissions in the UL band combination.

Furthermore, according to the embodiments of the present invention, there is provided a base station apparatus for communicating with user equipment, the base station apparatus including a management unit that requests terminal capability information including information indicating whether simultaneous transmissions are allowed in an uplink band combination and information indicating maximum sensitivity degradation when the simultaneous transmissions are executed in the uplink band combination; a receiving unit that receives the requested terminal capability information from the user equipment; and a transmitting unit that transmits an uplink scheduling allocation determined based on the terminal capability information to the user equipment, wherein the base station apparatus executes simultaneous receptions in the uplink band combination based on the uplink scheduling allocation.

With the above-described configuration, the base station apparatus 100 can perform, by receiving MSD when the simultaneous transmissions are executed in the uplink band combination, scheduling in which an effect of IMD tends not to be received, and the user equipment 200 can perform uplink simultaneous transmissions in which an effect of in-device interference is reduced, based on the scheduling.

Furthermore, according to the embodiments of the present invention, there is provided user equipment for communicating with a base station apparatus, the user equipment including a generating unit that generates terminal capability information including information indicating an uplink band combination and information indicating whether simultaneous transmissions in the uplink band combination are allowed; a transmitting unit that transmits the generated terminal capability information to the base station apparatus; and a receiving unit that receives an uplink scheduling allocation from the base station apparatus, wherein the user equipment executes the simultaneous transmissions in the uplink band combination based on the uplink scheduling allocation.

With the above-described configuration, the base station apparatus 100 can obtain information of terminal capability related to multi-RAT dual connectivity of the user equipment 200 by reporting, by the user equipment 200, a band combination formed of an LTE band and an NR band, as the terminal capability, i.e., as UECapabilityInformation, to the base station apparatus 100 during multi-RAT dual connectivity using a plurality of RATs. Furthermore, when a UL band combination is reported as LTE-NR dual connectivity by UECapabilityInformation, the base station apparatus 100 can perform scheduling by obtaining information indicating whether the user equipment 200 supports UL simultaneous transmissions in the UL band combination. Namely, communication can be executed such that an effect of in-device interference can be reduced during dual connectivity executed in a radio communication system using multiple RATs.

When simultaneous transmissions are allowed in a first uplink band combination, information indicating whether the simultaneous transmissions are allowed in the first uplink band combination may not be included in the terminal capability information, and, when simultaneous transmissions are disallowed in a second uplink band combination, information indicating that the simultaneous transmissions are not allowed in the second uplink band combination may be included in the terminal capability information. With this configuration, when a UL band combination of LTE-NR dual connectivity is reported by UECapabilityInformation, the base station apparatus 100 can execute scheduling by obtaining information indicating that the user equipment 200 supports UL simultaneous transmissions in the UL band combination.

When uplink transmission is allowed in each of a plurality of uplink bands included in the uplink band combination, information indicating that single band transmission is allowed may be included in the terminal capability information. With this configuration, when a UL band combination of LTE-NR dual connectivity is reported and the terminal capability “single Tx UE” is reported by UECapabilityInformation, the base station apparatus 100 can obtain information indicating that user equipment 200 performs transmission with 1 CC in one band, in the UL band combination.

A value indicating maximum sensitivity degradation when simultaneous transmissions are performed in an uplink band combination may be included in the terminal capability information. With this configuration, by obtaining MSD, the base station apparatus 100 can perform scheduling in which an effect of IMD tends not to be received.

An uplink band combination may be associated with values representing a plurality of maximum sensitivity degradations, and information indicating one of the plurality of maximum sensitivity degradations may be included in the terminal capability information. With this configuration, the base station apparatus 100 can have knowledge of an extent of interference caused by IMD on a DL band when the user equipment 200 executes UL simultaneous transmissions, so that the base station apparatus 100 can perform scheduling with which an effect of IMD tends not to be received by appropriately selecting UL dual transmissions or UL single transmission.

Furthermore, according to the embodiments of the present invention, there is provided a base station apparatus for communicating with user equipment, the base station apparatus including a management unit that requests terminal capability information including information indicating whether simultaneous transmissions are allowed in an uplink band combination; a receiving unit that receives the requested terminal capability information from the user equipment; and a transmitting unit that transmits an uplink scheduling allocation determined based on the terminal capability information to the user equipment, wherein the base station apparatus executes simultaneous receptions in the uplink band combination based on the uplink scheduling allocation.

With the above-described configuration, by reporting, by the user equipment 200, a band combination formed of an LTE band and an NR band to the base station apparatus 100, as the terminal capability, i.e., as UECapabilityInformation, during multi-RAT dual connectivity using multiple RATs, the base station apparatus 100 can obtain information on terminal capability of the user equipment 200 related to multi-RAT dual connectivity. Furthermore, when a UL band combination of LTE-NR dual connectivity is reported by UECapabilityInformation, the base station apparatus 100 can perform scheduling by obtaining the information indicating whether the user equipment 200 supports UL simultaneous transmissions in the UL band combination. Namely, communication can be executed such that an effect of in-device interference can be reduced during dual connectivity executed in a radio communication system using multiple RATs.

### Supplemental Embodiments

The embodiments of the present invention are described above. However, the disclosed invention is not limited to the above-described embodiments, and those skilled in the art would appreciate various modified examples, revised examples, alternative examples, substitution examples, and so forth. In order to facilitate understanding of the invention, specific numerical value examples are used for description. However, the numerical values are merely examples, and any suitable values may be used unless as otherwise specified. The classification of items in the above description is not essential to the present invention. Matter described in two or more items may be combined and used as necessary, and matter described in one item may be applied to matter described in another item (provided that they do not contradict). The boundary between functional units or processing units in a functional block diagram does not necessarily correspond to the boundary between physical components. Operations of a plurality of functional units may be performed physically by one component, or an operation of one functional unit may be physically performed by a plurality of parts. The order of the procedures described in the embodiments may be changed, provided that they do not contradict. For the sake of convenience of processing description, the base station apparatus 100 and the user equipment 200 are described using the functional block diagrams. However, such devices may be implemented by hardware, software, or a combination thereof. Each of software executed by the processor included in the base station apparatus 100 according to the embodiments of the present invention and software executed by the processor included in the user equipment 200 according to the embodiments of the present invention may be stored in a random access memory (RAM), a flash memory, a read only memory (ROM), an EPROM, an EEPROM, a register, a hard disk (HDD), a removable disk, a CD-ROM, a database, a server, or any other appropriate storage medium.

Notification of information is not limited the aspects/embodiments described in the present specification and may be performed by other methods. For example, notification of information may be performed via physical layer signaling (for example, Downlink Control Information (DCI) or Uplink Control Information (UCI)), higher-layer signaling (for example, RRC signaling, MAC signaling, broadcast information (Master Information Block (MIB), or System Information Block (SIB)), other signals, or by a combination thereof. Moreover, an RRC message may be referred to as the RRC signaling.

Furthermore, the RRC message may be an RRC connection setup (RRC Connection Setup) message, a RRC connection reconfiguration (RRC Connection Reconfiguration) message, or the like, for example.

Each aspect/embodiment described in this specification can be applied to long term evolution (LTE), LTE-advanced (LTE-A), SUPER 3G, IMT-Advanced, 4G, 5G, future radio access (FRA), W-CDMA (registered trademark), GSM (registered trademark), CDMA2000, ultra mobile broadband (UMB), IEEE 802.11 (Wi-Fi), IEEE 802.16 (WiMAX), IEEE 802.20, ultra-wideband (UWB), Bluetooth (registered trademark), any other systems using an appropriate system and/or next generation systems extended on the basis of these systems.

In processing procedures, sequences, flowcharts, etc., of each embodiment/modified example described in the specification, the order may be changed provided that there is no contradiction. For example, for the methods described in the specification, the elements of the various steps are presented in an exemplary order and are not limited to a specific order presented.

The specific operations that are described in the specification to be performed by the base station apparatus 100 may be performed by their upper nodes in some cases. In a network formed of one or more network nodes including the base station apparatus 100, it is apparent that the various operations performed for communication with the user equipment 200 may be performed by the base station apparatus 100 and/or a network node other than the base station apparatus 100 (e.g., MME or S-GW can be considered, however, not limited to these). In the above description, a case is exemplified in which there is one network node other than the base station apparatus 100. However, it can be a combination of other network nodes (e.g., MME and S-GW).

Each aspect/embodiment described in this specification may be used alone, may be used in combination, or may be used while being switched during the execution.

The user equipment 200 may be referred to, by a person ordinarily skilled in the art, as a subscriber station, a mobile unit, a subscriber unit, a wireless unit, a remote unit, a mobile device, a wireless device, a wireless communication device, a remote device, a mobile subscriber stations, an access terminal, a mobile terminal, a wireless terminal, a remote terminal, a handset, a user agent, a mobile client, a client, or it may also be called by some other suitable terms.

The base station apparatus 100 may be referred to, by a person ordinarily skilled in the art, as a NodeB (NB), an enhanced NodeB (eNB), gNB, a base station (Base Station), or any other suitable terms.

The terms “determine (determining)” and “decide (determining)” used in this specification may include various types of operations. For example, “determining” and “deciding” may include deeming that a result of judging, calculating, computing, processing, deriving, investigating, looking up (e.g., search in a table, a database, or another data structure), or ascertaining is determined or decided. Furthermore, “determining” and “deciding” may include, for example, deeming that a result of receiving (e.g., reception of information), transmitting (e.g., transmission of information), input, output, or accessing (e.g., accessing data in memory) is determined or decided. Furthermore, “determining” and “deciding” may include deeming that a result of resolving, selecting, choosing, establishing, or comparing is determined or decided. Namely, “determining” and “deciding” may include deeming that some operation is determined or decided.

The expression “based on” used in the present specification does not mean “based on only” unless as otherwise specified explicitly. In other words, the expression “based on” means both “based on only” and “based on at least.”

As long as “include,” “including,” and variations thereof are used in this specification or the claims, the terms are intended to be inclusive in a manner similar to the term “comprising.” Furthermore, the term “or” used in the specification or claims is intended not to be an exclusive OR.

In the whole of the present disclosure, for example, if articles are added by translation, such as “a,” “an,” and “the,” these articles may include a plural forms, unless as otherwise indicated explicitly by the context.

Note that, in the embodiments of the present invention, the terminal capability generating unit 240 is an example of a generating unit. The terminal capability management unit 140 is an example of a management unit. UECapabilityInformation is an example of terminal capability information. The bit indicating that “single Tx UE” is supported is an example of information representing that single band transmission is allowed. The bit indicating that “simultaneous transmissions are not allowed in the UL band combination” is an example of information indicating that simultaneous transmissions are not allowed. MSD is an example of a value or information representing maximum sensitivity degradation.

The present invention is described in detail above. It is apparent for a person ordinarily skilled in the art that the present invention is not limited to the embodiments described in the present specification. The present invention can be implemented as modified embodiments and altered embodiments without departing from the gist and scope of the present invention defined by the scope of the claims. Accordingly, the descriptions of the present specification are for the purpose of illustration and do not have any restrictive meaning to the present invention.

This international patent application is based on and claims priority to Japanese Patent Application No. 2017-219472 filed on Nov. 14, 2017, and the entire content of Japanese Patent Application No. 2017-219472 is incorporated herein by reference.

### LIST OF REFERENCE SYMBOLS

100 base station apparatus
200 user equipment
110 transmitting unit
120 receiving unit
130 configuration information management unit
140 terminal capability management unit
200 user equipment
210 transmitting unit
220 receiving unit
230 configuration information management unit
240 terminal capability generating unit
1001 processor
1002 storage device
1003 auxiliary storage device
1004 communication device
1005 input device
1006 output device

1. User equipment for communicating with a base station apparatus, the user equipment comprising:
a generating unit that generates terminal capability information including information indicating an uplink band combination; information indicating whether simultaneous transmissions in the uplink band combination are allowed; and information indicating maximum sensitivity degradation when the simultaneous transmissions are executed in the uplink band combination;
a transmitting unit that transmits the generated terminal capability information to the base station apparatus; and
a receiving unit that receives an uplink scheduling allocation from the base station apparatus,
wherein the user equipment executes the simultaneous transmissions in the uplink band combination based on the uplink scheduling allocation.

2. The user equipment according to claim 1, wherein the terminal capability information includes only one item of the information indicating the maximum sensitivity degradation in the user equipment.

3. The user equipment according to claim 2, wherein the information indicating the maximum sensitivity degradation is included in the terminal capability information including information indicating maximum sensitivity degradation when the user equipment executes simultaneous transmissions in each of corresponding one or more uplink band combinations.

4. The user equipment according to claim 3, wherein the uplink band combination is associated with a plurality of items of information representing the maximum sensitivity degradation, and
wherein, for each uplink band combination, information indicating one of the plurality of items of the information representing the maximum sensitivity gradation is included in the terminal capability information.

5. The user equipment according to claim 1, wherein, when simultaneous transmissions are allowed in a first uplink band combination, the user equipment implicitly reports, to the base station apparatus, that the simultaneous transmissions are allowed by not including information indicating whether the simultaneous transmissions in the first uplink band combination are allowed in the terminal capability information, and
wherein, when simultaneous transmissions are disallowed in a second uplink band combination, the user equipment includes information indicating that the simultaneous transmissions are not allowed in the second uplink band combination in the terminal capability information.

6. A base station apparatus for communicating with user equipment, the base station apparatus comprising:
a management unit that requests terminal capability information including information indicating whether simultaneous transmissions are allowed in an uplink band combination and information indicating maximum sensitivity degradation when the simultaneous transmissions are executed in the uplink band combination;
a receiving unit that receives the requested terminal capability information from the user equipment; and
a transmitting unit that transmits an uplink scheduling allocation determined based on the terminal capability information to the user equipment,
wherein the base station apparatus executes simultaneous receptions in the uplink band combination based on the uplink scheduling allocation.
